(19) United States
(12) Patent Application Publication
(10) Pub. No.: US 2017/0173739 A1
(43) Pub. Date: Jun. 22, 2017

(54) METAL COMPOSITION, BONDING MATERIAL

(71) Applicant: Murata Manufacturing Co., Ltd., Nagaokakyo-shi (JP)

(72) Inventor: Yoshihiro Kawaguchi, Nagaokakyo-shi (JP)

(21) Appl. No.: 15/447,360

(22) Filed: Mar. 2, 2017

Related U.S. Application Data
(63) Continuation of application No. PCT/JP2015/072596, filed on Aug. 10, 2015.

(30) Foreign Application Priority Data
Sep. 9, 2014 (JP) 2014-183549

(51) Int. Cl. B23K 35/02; B23K 35/36; B23K 35/26

(52) U.S. Cl. CPC B23K 35/025; B23K 35/262; B23K 35/3613; B23K 35/3618

(57) ABSTRACT

A metal composition that includes a metal component and a flux. The metal component is composed of a first metal powder of a Sn-based metal, and a second metal powder of a Cu-based metal that has a higher melting point than the Sn-based metal. The flux includes a rosin, a solvent, a thixotropic agent, an activator, and the like. When the metal composition is heated to a temperature equal to or higher than the melting point of the first metal powder, the first metal powder is melted. The melted Sn and the CuNi alloy powder produce an intermetallic compound phase of a CuNiSn alloy through a TLP reaction.

### CROSS REFERENCE TO RELATED APPLICATIONS

The present application is a continuation of International application No. PCT/JP2015/072596, filed Aug. 10, 2015, which claims priority to Japanese Patent Application No. 2014-183549, filed Sep. 9, 2014, the entire contents of each of which are incorporated herein by reference.

### FIELD OF THE INVENTION

The present invention relates to a metal composition including a metal component and a flux component, and a bonding material including the metal composition.

### BACKGROUND OF THE INVENTION

Conventionally, metal compositions are used in bonding, for example, a first object to be bonded and a second object to be bonded. For examples, Patent Document 1 discloses a metal paste (metal composition) for use in mounting a multilayer ceramic capacitor (second object to be bonded) on a printed board (first object to be bonded). The metal paste bonds lands provided on the printed board and external electrodes provided for the multilayer ceramic capacitor.

The metal paste includes: a metal component including a Sn powder and a CuNi alloy powder; and a flux component including a rosin and an activator. Then, the Sn powder and CuNi alloy powder included in the metal paste, on heating, produce a CuNiSn alloy with liquid-phase diffusion (hereinafter, “TLP: Transient Liquid Phase Diffusion”) bonding.

In this regard, the heating temperature is equal to or higher than the melting point of the Sn and lower than the melting point of the CuNi alloy, and for example, 250 to 350° C. The CuNiSn alloy is an intermetallic compound, which has a high melting point (for example, 400° C. or higher).

As just described, in the metal paste, a TLP reaction proceeds through a heat treatment at a relatively low temperature, and the obtained metal body is changed to a metal body containing, as its main phase, an intermetallic compound that has a melting point equal to or higher than the heat treatment temperature. As a result, the metal body subjected to the heat treatment serves as a highly heat-resistant bonding material.

It is to be noted that the rosin and activator included in the metal paste is added for removing (reducing) oxide films of metal powders and objects to be bonded, as with flux components in common solder pastes. In this regard, typically, the content ratios (wt %) of a rosin and an activator in a solder paste meet the inequality of rosin>activator, and the additive amount of the activator in the solder paste is not larger than the additive amount of the rosin therein.

Patent Document 1: WO 2012/108395

### SUMMARY OF THE INVENTION

However, when the CuNi alloy power is reduced in particle size, the degree of oxidation at the CuNi alloy powder surface is increased, there is thus a tendency to cause the rosin and the activator to reduce the CuNi alloy powder surface insufficiently, thereby worsening the wettability between Sn and CuNi.

Thus, in the TLP reaction, the reaction between the Sn and the CuNi can proceed insufficiently, or the melted Sn may repel the solid CuNi alloy powder, thereby separating the two.

An object of the present invention is to provide a metal composition and a bonding material which serve as highly heat-resistant materials through a heat treatment at a low temperature.

A metal composition according to the present invention includes: a metal component including a first metal powder and a second metal powder that has a higher melting point than the first metal powder; and a flux component. In this regard, for example, the first metal powder is preferably one of a Sn powder and an alloy powder including Sn, and the second metal powder is preferably a CuNi alloy powder. The metal composition is included in, for example, a bonding material.

Further, the metal composition according to the present invention is characterized in that an amount to be reduced by hydrogen reduction of the second metal powder is 0.75 wt % or less.

In this aspect, when the metal composition is heated, the first metal powder and second metal powder included in the metal composition develop a liquid-phase diffusion (hereinafter, “TLP”) reaction, thereby producing an intermetallic compound. The heating temperature is equal to or higher than the melting point of the first metal and lower than the melting point of the second metal, and for example, 250 to 350° C. The intermetallic compound has a high melting point (for example, 400° C. or higher) that is equal to or higher than the heating temperature.

When the amount to be reduced by hydrogen reduction for the second metal powder is 0 wt % or more and 0.75 wt % or less, the second metal powder surface is reduced sufficiently with a rosin and an activator due to the low degree of oxidation at the second metal powder surface.

Therefore, the TLP reaction proceeds through a heat treatment at a relatively low temperature in the metal composition according to this aspect. More specifically, the metal composition according to this aspect serves as a highly heat-resistant material through a heat treatment at a low temperature.

Further, the second metal powder has a specific surface area larger than 0 m²/g and smaller than 0.61 m²/g.

On the other hand, when the second metal powder has a specific surface area of 0.61 m²/g or larger, the surface of the second metal powder has a degree of oxidation increased because of the large specific surface area of the second metal powder.

Therefore, preferably, the flux component includes a rosin and an activator, and a ratio of the weight of the activator to the weight of the rosin is 1.0 or more. In this case, because of the high reduction power, the surface of the second metal powder is reduced sufficiently with the rosin and the activator.

In addition, the rosin preferably has an acid number of 130 or more. The increased acid number of the rosin is equivalent to the increased amount of a resin acid. The carboxyl group of the resin acid and an oxide film at the surface of the second metal powder react during heating, thereby removing the oxide film.

Therefore, the rosin with a larger acid number has a greater effect of reducing an oxide film at the metal powder surface.

In addition, the activator preferably has a carboxyl group. The carboxyl group of the activator and an oxide film at the surface of the second metal powder react during heating, thereby removing the oxide film. The carboxyl group reduces the surface of the metal powder.

Further, the metal composition is preferably shaped in a sheet, putty, or paste form.

According to the present invention, a metal composition can be provided which serves as a highly heat-resistant material through a heat treatment at a low temperature.

### BRIEF EXPLANATION OF THE DRAWINGS

FIGS. 1(A) to 1(C) are cross-sectional views schematically illustrating a reaction process for a metal composition according to an embodiment of the present invention.

FIG. 2 is a side view of an electronic component 24 mounted over lands 21 formed on a printed wiring board 22, with a metal paste 25 interposed therebetween.

FIG. 3 is a perspective view of the appearance of a pipe 310 with a repairing sheet 303 attached to a damaged part DP.

FIG. 4 is a perspective view of the appearance of a rolled body 300 obtained by rolling the repairing sheet 303 shown in FIG. 3.

FIG. 5 is a cross-sectional view of a bolt 50 with a metal putty 31 applied thereto.

FIG. 6 is a cross-sectional view of the bolt 50 shown in FIG. 5 after heating the bolt.

FIG. 7 is a cross-sectional view of the bolt 50 shown in FIG. 5 after reheating the bolt.

### DETAILED DESCRIPTION OF THE INVENTION

A metal composition according to an embodiment of the present invention will be described below.

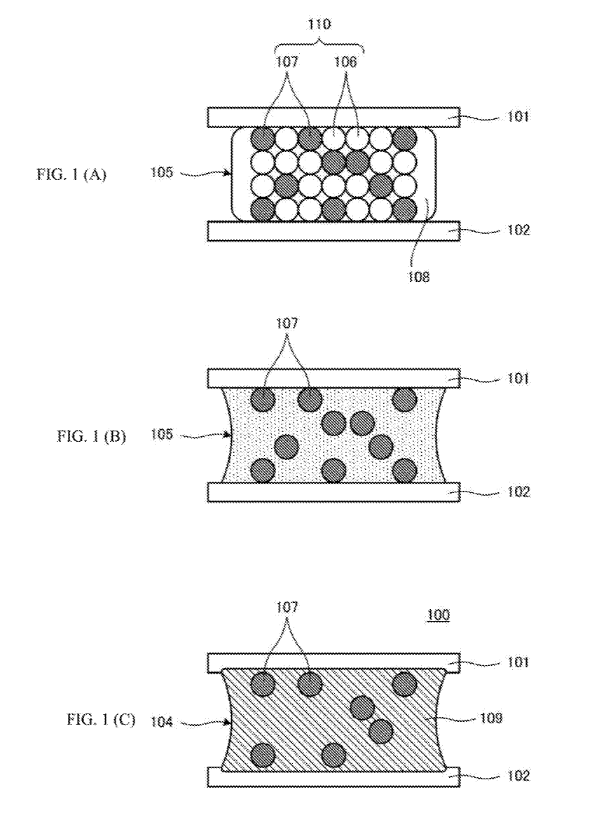

FIGS. 1(A) to 1(C) are cross-sectional views schematically illustrating a reaction process for a metal composition according to an embodiment of the present invention.

The metal composition 105 is, as shown in FIG. 1(A), used for, for example, bonding a first object 101 to be bonded and a second object 102 to be bonded. More specifically, the metal composition 105 is used as, for example, a bonding material.

The first object 101 to be bonded is a pipe, a nut, and an electronic component such as a multilayer ceramic capacitor, for example. The second object 102 to be bonded is, for example, a base material sheet constituting a repairing sheet attached to a pipe, a bolt fitted into a nut, and a printed board mounted with an electronic component.

In order to obtain a bonded structure 100 as shown in FIG. 1(C), first, the metal composition 105 is provided between the first object 101 to be bonded and the second object 102 to be bonded as shown in FIG. 1(A). The metal composition 105 is shaped, for example, in a sheet, putty, or paste form.

The metal composition 105 includes a metal component 110 and a flux 108. The metal component 110 is uniformly dispersed in the flux 108. The metal component 110 is composed of a first metal powder 106 of a Sn-based metal; and a second metal powder 107 of a Cu-based metal that has a higher melting point than the Sn-based metal.

A material for the first metal powder 106 is Sn.

A material for the second metal powder 107 can react with the first metal powder 106 melted by heating the metal composition 105, thereby producing an intermetallic compound. In the present embodiment, the material for the second metal powder 107 is a Cu—Ni alloy, more specifically, a Cu-10Ni alloy.

Next, the flux 108 includes a rosin, a solvent, a thixotropic agent, and an activator. The flux 108 serves the function of removing oxide films at the surfaces of the objects to be bonded and metal powders.

The rosin is, for example, a rosin-based resin composed of a modified rosin obtained by modifying a rosin and a derivative of a rosin or the like, a synthetic resin composed of a derivative of the resin, or a mixed product thereof.

The rosin-based resin is, for example, a polymerized rosin, a gum rosin, a tall rosin, a wood rosin, a hydrogenated rosin, a formylated rosin, a rosin ester, a rosin-modified maleic acid resin, a rosin-modified phenolic resin, a rosin-modified alkyd resin, and various other types of rosin derivatives.

The synthetic resin is, for example, a polyester resin, a polyamide resin, a phenoxy resin, a terpene resin, or the like.

The solvent is, for example, an alcohol, a ketone, an ester, an ether, an aromatic, or a hydrocarbon.

The thixotropic agent is, for example, a hydrogenated castor oil, a carnauba wax, an amide, a hydroxy fatty acid, a dibenzylidenesorbitol, a bis(p-methylbenezylidene)sorbitol, a beeswax, a stearic acid, or a hydroxy stearic acid ethylene bisamide.

In addition, the activator is, for example, a hydrohalogenic acid salt of an amine, an organic halogen compound, an organic acid, an organic amine, or a polyalcohol. In this regard, the activator preferably has a carboxyl group such as a monocarboxylic acid, a dicarboxylic acid, and a tricarboxylic acid. The carboxyl group reacts with an oxide film at the metal powder surface, thereby reducing the metal powder surface.

The hydrohalogenic acid salt of an amine is, for example, a diphenylguanidine hydrobromide, a diphenylguanidine hydrochloride, a cyclohexylamine hydrobromide, an ethylamine hydrochloride, an ethylamine hydrobromide, a diethylaniline hydrobromide, a diethylaniline hydrochloride, a triethanolamine hydrobromide, or a monoethanolamine hydrobromide.

The organic halogen compound is, for example, a chlorinated paraffin, a tetrabromoethane, a dibromopropanol, 2,3-dibromo-1,4-butanediol, 2,3-dibromo-2-butene-1,4-diol, or tris(2,3-dibromopropyl)isocyanurate.

The organic acid is, for example, an adipic acid, a sebacic acid, a malonic acid, a fumaric acid, a glycolic acid, a citric acid, a malic acid, a succinic acid, a phenylsuccinic acid, a maleic acid, a salicylic acid, an anthranilic acid, a glutaric acid, a suberic acid, a stearic acid, an abietic acid, a benzoic acid, a trimellitic acid, a pyromellitic acid, or a dodecanoic acid.

The organic amine is, for example, a monoethanolamine, a diethanolamine, a triethanolamine, a tributylamine, an aniline, or a diethylaniline.

The polyalcohol is, for example, erythritol, pyrogallol, or ribitol.

Next, the metal composition 105 is subjected to hot-air heating in the condition shown in FIG. 1(A). Thus, when the metal composition 105 reaches a temperature equal to or higher than the melting point of the first metal powder 106, the first metal powder 106 is melted as shown in FIG. 1(B). The heating temperature is equal to or higher than the melting point of Sn, and equal to or lower than the melting point of CuNi, and for example, 250 to 350° C.

Then, the melted Sn and the CuNi alloy powder of the second metal powder 107 produce a CuNiSn based alloy through a liquid-phase diffusion (hereinafter, “TLP”) reaction. The CuNiSn based alloy is an alloy containing at least two selected from the group consisting of Cu, Ni, and Sn. The CuNiSn based alloy is an intermetallic compound such as (Cu,Ni)₆Sn₅, Cu₄Ni₂Sn₅, Cu₅NiSn₅, (Cu,Ni)₃Sn, CuNi₂Sn, Cu₂NiSn, Ni₃Sn₄, or Cu₆Sn₅, which has a high melting point (for example, 400° C. or higher) equal to or higher than the heating temperature.

In FIG. 1(C), an intermetallic compound phase 109 of the CuNiSn based alloy (intermetallic compound) is shown.

As just described, the TLP reaction proceeds through a heat treatment at a relatively low temperature in the metal composition 105. As a result, the metal composition 105 serves as a highly heat-resistant bonding material 104.

For example, even in such a case as mounting a semiconductor device onto a substrate by a method of reflow soldering after manufacturing the semiconductor device through a step of carrying out soldering, for the manufacture of the semiconductor device, the high heat resistance of the bonding material 104 can provide the soldered part obtained by the previous soldering, with excellent strength against heat. Highly reliable mounting can be achieved without remelting in the step of reflow soldering.

Specific examples of using the metal composition 105 will be described below. First, an example of using the metal composition 105 shaped in the form of a paste will be described.

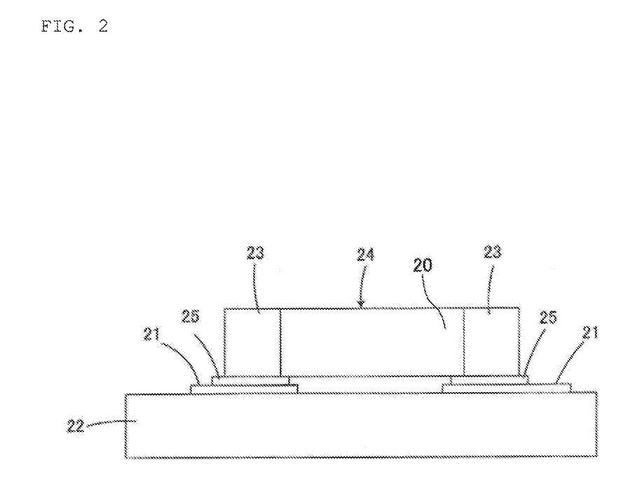

FIG. 2 is a side view of an electronic component 24 mounted over lands 21 formed on a printed wiring board 22, with a metal paste 25 interposed therebetween.

First, the metal paste 25 is provided on the lands 21 formed on the printed wiring board 22. The metal paste 25 includes a metal component 110 and a flux 108, as with the metal composition 105 shown in FIG. 1.

Next, the electronic component 24 is mounted on the lands 21 with a mounter. The electronic component 24 is a multilayer ceramic capacitor. The electronic component 24 has a ceramic laminated body 20 including a plurality of internal electrodes, and external electrodes 23 provided on both ends of the ceramic laminated body 20 and connected to each internal electrode.

Next, the electronic component 24 and the metal paste 25 are heated with the use of, for example, a reflow device. Thus, when the metal paste 25 reaches a temperature equal to or higher than the melting point of the first metal powder 106, the first metal powder 106 is melted as shown in FIG. 1(B).

Then, the melted Sn and the CuNi alloy powder of the second metal powder 107 produce a CuNiSn based alloy (intermetallic compound) through a TLP reaction.

As just described, the TLP reaction proceeds through a heat treatment at a relatively low temperature in the metal paste 25. As a result, the metal paste 25 serves as a highly heat-resistant bonding material 104.

Next, an example of using the metal composition 105 shaped in the form of a sheet will be described.

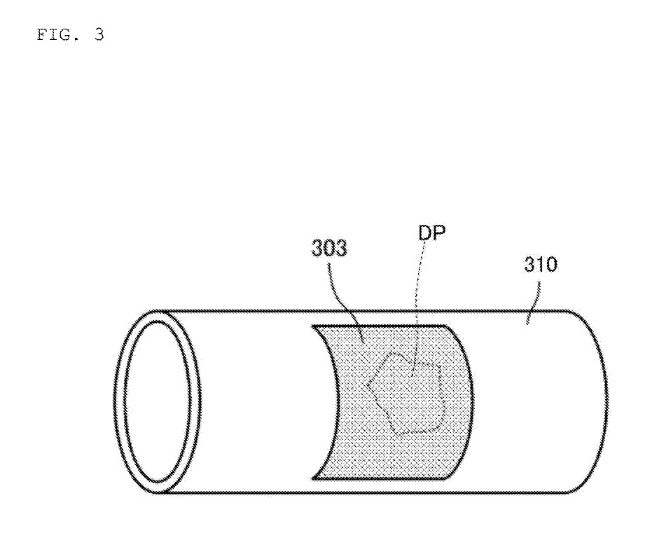

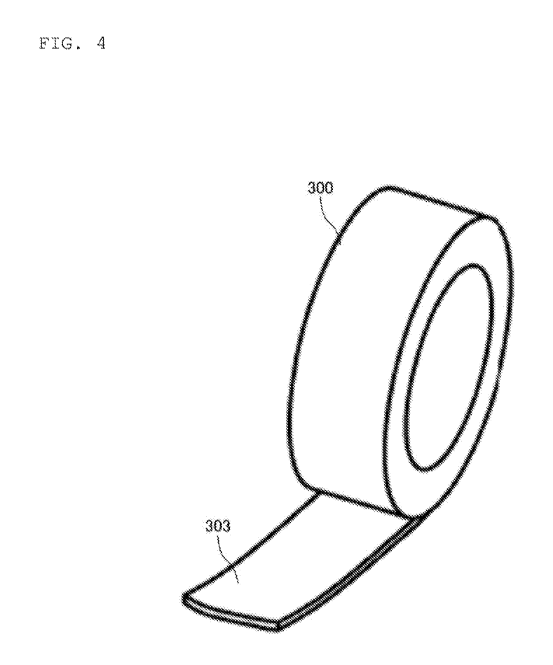

FIG. 3 is a perspective view of the appearance of a pipe 310 with a repairing sheet 303 attached to a damaged part DP. FIG. 4 is a perspective view of the appearance of a rolled body 300 obtained by rolling the repairing sheet 303 shown in FIG. 3.

First, the repairing sheet 303 is cut from the rolled body 300, and an adhesive surface of the repairing sheet 303 is attached to the pipe 310 so as to seal the damaged part DP of the pipe 310. The repairing sheet 303 has the adhesive surface.

The repairing sheet 303 has a metal sheet attached to a flexible base material sheet. This metal sheet includes a metal component 110 and a flux 108, as with the metal composition 105 as shown in FIG. 1. The base material sheet is composed of, for example, Cu.

Next, the repairing sheet 303 is subjected to hot-air heating. Thus, when the repairing sheet 303 reaches a temperature equal to or higher than the melting point of the first metal powder 106, the first metal powder 106 in the repairing sheet 303 is melted as shown in FIG. 1(B).

Then, the melted Sn and the CuNi alloy powder of the second metal powder 107 produce a CuNiSn based alloy (intermetallic compound) through a TLP reaction. As a result, the repairing sheet 303 has an intermetallic compound layer formed form the CuNiSn based alloy.

As just described, the TLP reaction proceeds through a heat treatment at a relatively low temperature in the repairing sheet 303, and the repairing sheet 303 can cover the damaged part DP with a highly heat-resistant intermetallic compound layer. Therefore, the repairing sheet 303 can repair the pipe 310.

Next, an example of using the metal composition 105 shaped in the form of a putty will be described.

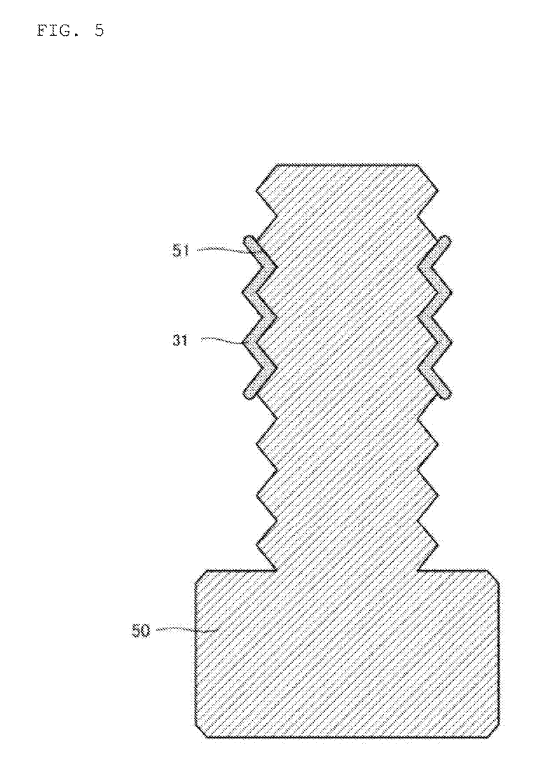

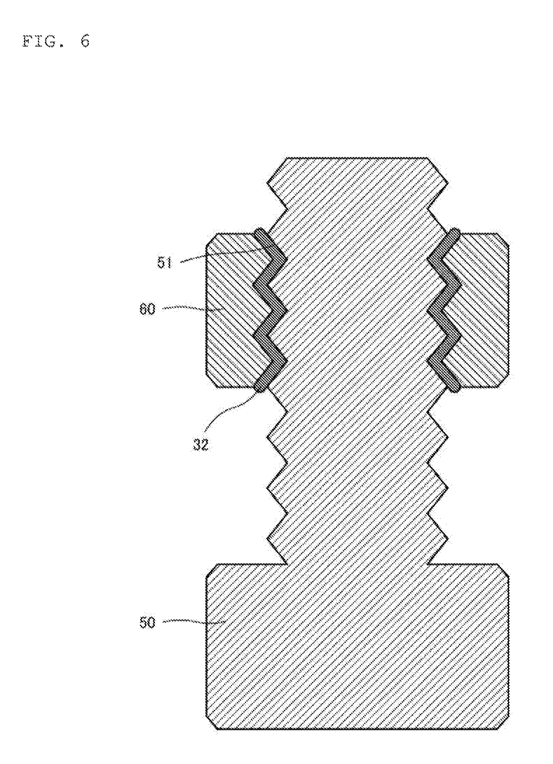

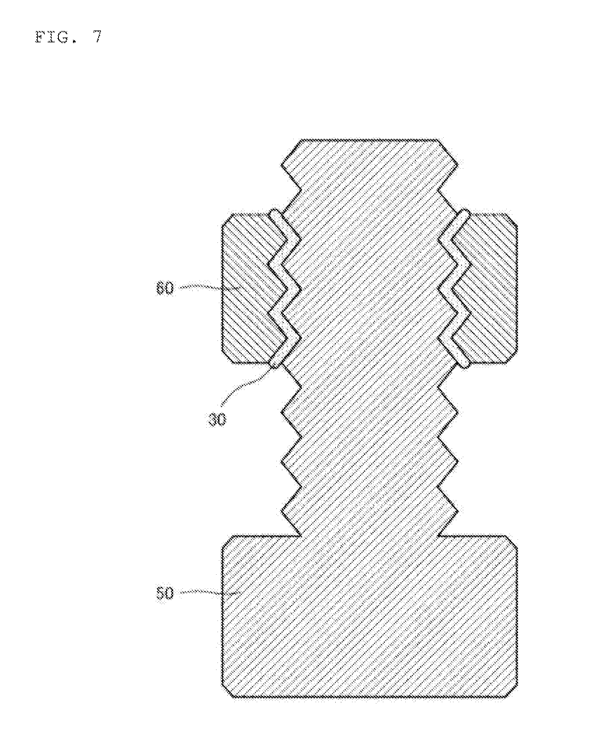

FIG. 5 is a cross-sectional view of a bolt 50 with a metal putty 31 applied thereto. FIG. 6 is a cross-sectional view of the bolt 50 shown in FIG. 5 after heating the bolt. FIG. 7 is a cross-sectional view of the bolt 50 shown in FIG. 5 after reheating the bolt.

First, as shown in FIG. 5, the metal putty 31 is applied to a screw part 51 of the bolt 50. The metal putty 31 also includes a metal component 110 and a flux 108, as with the metal composition 105 as shown in FIG. 1.

Next, the bolt 50 is fitted into a screw part 61 of a nut 60.

Next, the bolt 50 and the screw part of the nut 60 is heated with, for example, a hot air gun. Thus, when the metal putty 31 reaches a temperature equal to or higher than the melting point of the first metal powder 106, the first metal powder 106 is melted as shown in FIG. 1(B).

When the heating is completed, the first metal is naturally cooled and solidified to form a first metal phase. More specifically, the metal putty 31 serves as, at room temperature, a relatively dense metal member 32 with second metal particles dispersed in a metal body containing the first metal as its main constituent (see FIG. 6). As a result, the bolt 50 and the nut 60 are firmly bonded with the metal member 32.

Next, the bolt 50 and the screw part of the nut 60 is heated again with, for example, a hot air gun. Thus, when the metal member 32 that bonds the bolt 50 and the screw part of the nut 60 reaches a temperature equal to or higher than the melting point of the first metal powder 106, the melted Sn and the CuNi alloy powder of the second metal powder 107 produce a CuNiSn based alloy (intermetallic compound) through a TLP reaction.

As a result, the relatively dense metal member 32 is changed to an intermetallic compound member 30 with a relatively large number of vacancies (see FIG. 7).

Next, the bolt 50 and the nut 60 are separated with the intermetallic compound member 30 as a separated part.

In this regard, the intermetallic compound member 30 is a member where the vacancy ratio of the intermetallic compound member 30 is higher than the vacancy of the metal member 32. Therefore, users can easily separate the bolt 50 and the nut 60 with the intermetallic compound member 30 as a separated part.

Therefore, according to this example of use, the bolt 50 and the nut 60 can be easily and strongly bonded by the heating treatment, that is, the bolt 50 and the nut 60 can be easily prevented from being loosened, and the bolt 50 and the nut 60 can be easily separated by the reheating treatment.

Next, experimental examples provided by changing the structure of the metal composition 105 will be described.

### Experiment 1

In Experiment 1, multiple samples 1 to 5, 51 were prepared, which were made by mixing a metal component including a Sn powder (first metal powder) and a CuNi alloy powder (second metal powder), and a flux component including a rosin and an activator, and whether a TLP reaction proceeded or not was determined. The TLP reaction was determined by heating the multiple samples 1 to 5, 51 for 5 minutes at 250° C. under the atmospheric pressure with the use of, for example, a reflow device.

Table 1 shows the particle sizes (D50), the specific surface areas, and the amount to be reduced by hydrogen reduction for CuNi alloy powders. In addition, Table 2 shows information on the respective materials used for the multiple samples 1 to 5, 51, and the combination ratios of the respective materials.

TABLE 1

| | | | Amount to be | |
|---|---|---|---|---|
| | | | Reduced by | |
| | | Specific | Hydrogen | Whether TLP |
| Sample | Particle Size | Surface Area | Reduction of | Reaction |
| Number | of CuNi/μm | of CuNi/(m²/g) | CuNi/(Wt %) | Proceeded |
| 1 | 2.8 | 0.32 | 0.65 | Yes |
| 2 | 5.3 | 0.25 | 0.57 | Yes |
| 3 | 8.0 | 0.18 | 0.60 | Yes |
| 4 | 17 | 0.07 | 0.10 | Yes |
| 5 | 26 | 0.04 | 0.08 | Yes |
| 51 | 3.1 | 0.48 | 0.78 | No |

TABLE 2

| | | Combination |
|---|---|---|
| Material | Detailed Information of Material | Ratio (wt %) |
| Sn | SFR-Sn-10 (from Nippon Atomized | 63.0 |
| | Metal Powders Corporation) | |
| CuNi | See Table 1 | 27.0 |
| Rosin | Polymerized Rosin R-95 (from | 4.0 |
| | ARAKAWA CHEMICAL | |
| | INDUSTRIES, LTD.) | |
| Activator | Adipic Acid (from Wako Pure | 2.0 |
| | Chemical Industries, Ltd.) | |
| Solvent | Hexyldiglycol (HeDG) (from TOHO | 4.0 |
| | CHEMICAL INDUSTRY Co., Ltd.) | |

It is to be noted that the samples 1 to 5 are metal compositions according to examples of the present invention, whereas the sample 51 is a metal composition according to a comparative example for the examples of the present invention. In this regard, the particle size (D50) for the Sn powder is, for example, 10 μm. The specific surface area of the CuNi alloy powder is larger than 0 m²/g and smaller than 0.61 m²/g. In addition, the amount to be reduced by hydrogen reduction for the CuNi alloy powder is obtained in accordance with the measurement method specified by the JPMA P03-1992. Herein the amount refers to a weight reduction ratio that is obtained by measuring the initial weight of the CuNi alloy powder in advance, measuring the weight after reducing the CuNi alloy powder in hydrogen for 30 minutes at 875° C., and dividing the difference between the weights by the initial weight. In addition, an adipic acid as the activator has a carboxyl group.

From the experiment, in the case of the sample 51, it has become clear that the TLP reaction hardly proceeded as shown in Table 1. The reason of this result is believed to be because the amount to be reduced by hydrogen reduction for the CuNi alloy powder exceeded 0.75 wt %, that is, the degree of oxidation at the surface of the CuNi alloy powder was high, thus failing to reduce the surface of the CuNi alloy powder sufficiently with the rosin or the activator.

On the other hand, in the case of the multiple samples 1 to 5, it has become clear that the TLP reactions proceeded properly, thereby producing intermetallic compound phases as shown in Table 1. The reason of this result is believed to be because the amount to be reduced by hydrogen reduction for the CuNi alloy powder was 0.75 wt % or less, that is, the degree of oxidation at the surface of the CuNi alloy powder was low, thus sufficiently reducing the surface of the CuNi alloy powder with the rosin and the activator.

Therefore, the TLP reaction proceeds through a heat treatment at a relatively low temperature in the respective samples 1 to 5. As a result, the respective samples 1 to 5 serve as highly heat-resistant materials.

### Experiment 2

In Experiment 2, multiple samples 6 to 8, 52 to 55 were prepared, which were made by mixing a metal component including a Sn powder (first metal powder) and a CuNi alloy powder (second metal powder), and a flux component including a rosin and an activator, and whether a TLP reaction proceeded or not was determined. The TLP reaction was determined by heating the multiple samples 6 to 8, 52 to 55 for 5 minutes at 250° C. under the atmospheric pressure with the use of, for example, a reflow device.

The multiple samples 6 to 8, 52 to 55 differ from the multiple samples 1 to 5, 51 used in Experiment 1 mainly in that the specific surface area of the CuNi alloy powder is 0.61 m²/g or larger.

Table 3 shows the particle sizes (D50) of the CuNi alloy powders, the specific surface areas of the CuNi alloy powders, the amount to be reduced by hydrogen reduction for the CuNi alloy powders, the weight percent concentration of the rosin, the weight percent concentration of the activator, the ratio of the weight of the activator to the weight of the rosin, whether the separation between Sn and the CuNi alloy powder was achieved or not, and whether the TLP reaction proceeded or not. In addition, Table 4 shows information of the respective materials used for the multiple samples 6 to 8, 52 to 55, and the combination ratios of the respective materials.

TABLE 3

| | | | Amount to be | | | | | |
|---|---|---|---|---|---|---|---|---|
| | | | Reduced by | Rosin | Activator | | Separation | Whether |
| | Particle | Specific | Hydrogen | Amount in | Amount in | | between Sn | TLP |
| Sample | Size of | Surface Area | Reduction of | Paste | Paste | Activator/Rosin | and CuNi | Reaction |
| Number | CuNi/μm | of CuNi/(m²/g) | CuNi/(Wt %) | (wt %) | (wt %) | Ratio | Powder | Proceeded |
| 6 | 1.1 | 1.15 | 0.36 | 2.0 | 3.0 | 1.50 | No | Yes |
| 7 | 2.4 | 0.61 | 0.22 | 2.0 | 2.0 | 1.00 | No | Yes |
| 8 | 1.9 | 0.65 | 0.75 | 2.0 | 4.0 | 2.00 | No | Yes |
| 52 | 1.1 | 1.15 | 0.36 | 2.0 | 1.5 | 0.75 | Yes | Partially |
| 53 | 2.4 | 0.61 | 0.22 | 2.0 | 1.0 | 0.50 | Yes | Partially |
| 54 | 2.4 | 0.61 | 0.22 | 5.0 | 0.5 | 0.10 | Yes | Partially |
| 55 | 1.9 | 0.65 | 0.75 | 5.0 | 0.5 | 0.10 | Yes | Partially |

TABLE 4

| | | Combination |
|---|---|---|
| Material | Detailed Information of Material | Ratio (wt %) |
| Sn | SFR-Sn-10 (from Nippon Atomized | 63.0 |
| | Metal Powders Corporation) | |
| CuNi | See Table 3 | 27.0 |
| Rosin | Polymerized Rosin R-95 (from | See Table 3 |
| | ARAKAWA CHEMICAL | |
| | INDUSTRIES, LTD.) | |
| Activator | Sebacic Acid (from Wako Pure | See Table 3 |
| | Chemical Industries, Ltd.) | |
| Solvent | Hexyldiglycol (HeDG) (from TOHO | Balance |
| | CHEMICAL INDUSTRY Co., Ltd.) | |

It is to be noted that the samples 6 to 8 are metal compositions according to examples of the present invention, whereas the samples 52 to 55 are metal compositions according to comparative examples for the examples of the present invention. In addition, a sebacic acid as the activator has a carboxyl group.

From the experiment, in the case of the samples 52, 53, it has become clear that the TLP reactions proceeded only locally with the Sn and CuNi alloy powder separated, as shown in Table 3.

The reason of this result is believed to be because the specific surface area of the CuNi alloy powder was 0.61 m²/g or larger, that is, the proportion of the surface area to be reduced was increased in the CuNi alloy powder included in the paste, thus failing to reduce the surface of the CuNi alloy powder sufficiently with the rosin or the activator.

In addition, from the experiment, in the case of the samples 54, 55, it has become clear that the TLP reactions proceeded only locally with the Sn and CuNi alloy powder separated, even with the larger amounts of rosin than in the samples 52, 53, as shown in Table 3.

The reason of this result is believed to be because the specific surface area of the CuNi alloy powder was 0.61 m²/g or larger, that is, the proportion of the surface area to be reduced was increased in the CuNi alloy powder included in the paste, thus failing to reduce the surface of the CuNi alloy powder sufficiently, even with the further increased amount of the rosin lower in ability to reduce the CuNi alloy powder surface than the activator.

On the other hand, in the case of the multiple samples 6 to 8, it has become clear that the TLP reactions proceeded properly without separation between the Sn and the CuNi alloy powder, thereby producing intermetallic compound phases as shown in Table 3.

The reason of this result is believed to be because the specific surface area of the CuNi alloy powder was 0.61 m²/g or larger, while the reduction power of the activator was high due to the fact that the ratio of the weight of the activator to the weight of the rosin was 1.0 or more (that is, the amount of the activator was larger), thus sufficiently reducing the surface of the CuNi alloy powder with the activator.

Therefore, the TLP reaction proceeds through a heat treatment at a relatively low temperature in the respective samples 6 to 8. As a result, the respective samples 6 to 8 serve as highly heat-resistant materials.

### Experiment 3

In Experiment 3, multiple samples 9 to 12, 56, 57 were prepared, which were made by mixing a metal component including a Sn powder (first metal powder) and a CuNi alloy powder (second metal powder), and a flux component including a rosin and an activator, and whether a TLP reaction proceeded or not was determined. The TLP reaction was determined by heating the multiple samples 9 to 12, 56, 57 for 5 minutes at 250° C. under the atmospheric pressure with the use of, for example, a reflow device.

Table 5 shows the type of the rosin, the acid number of the rosin, and whether the TLP reaction proceeded or not. In addition, Table 6 shows information on the respective materials used for the multiple samples 9 to 12, 56, 57, and the combination ratios of the respective materials.

TABLE 5

| | | | Whether TLP |
|---|---|---|---|
| Sample | | | Reaction |
| Number | Type of Rosin | Acid Number | Proceeded |
| 9 | Polymerized Rosin R-95 | 158 to 168 | Yes |
| 10 | Acid-modified Ultra- | 305 to 345 | Yes |
| | pale Rosin KR-120 | | |
| 11 | Acid-modified Ultra- | 230 to 245 | Yes |
| | pale Rosin KE-604 | | |
| 12 | Ultra-pale Polymerized | 130 to 160 | Yes |
| | Rosin KR-140 | | |
| 56 | Ultra-pale Rosin Ester | 2 to 10 | No |
| | KE-100 | | |
| 57 | Ultra-pale Rosin Ester | 10 to 20 | No |
| | KE-359 | | |

TABLE 6

| | | Combination |
|---|---|---|
| Material | Detailed Information of Material | Ratio (wt %) |
| Sn | SFR-Sn-10 (from Nippon Atomized | 63.0 |
| | Metal Powders Corporation) | |
| CuNi | 30 μm CuNi Powder | 27.0 |
| Rosin | See Table 5 (from ARAKAWA | 4.0 |
| | CHEMICAL INDUSTRIES, LTD.) | |
| Activator | Sebacic Acid from Wako Pure | 2.0 |
| | Chemical Industries, Ltd.) | |
| Solvent | Hexyldiglycol (HeDG) (from TOHO | 4.0 |
| | CHEMICAL INDUSTRY Co., Ltd.) | |

It is to be noted that the samples 9 to 12 are metal compositions according to examples of the present invention, whereas the samples 56 to 57 are metal compositions according to comparative examples for the examples of the present invention. In the multiple samples 9 to 12, 56, 57, the specific surface area of the CuNi alloy powder is smaller than 0.61 m²/g. In addition, a sebacic acid as the activator has a carboxyl group. The CuNi alloy powder is 30 μm in particle size (D50).

From the experiment, in the case of the samples 56, 57, it has become clear that the TLP reaction failed to proceed as shown in Table 5. The reason of this result is believed to be because the specific surface area of the CuNi alloy powder was smaller than 0.61 m²/g, while the acid number of the rosin was less than 130, that is, the reduction power of the rosin was low, thus failing to reduce the surface of the CuNi alloy powder sufficiently with the rosin or the activator.

On the other hand, in the case of the multiple samples 9 to 12, it has become clear that the TLP reactions proceeded properly, thereby producing intermetallic compound phases as shown in Table 5. The reason of this result is believed to be because the acid number of the rosin was 130 or more, that is, the reduction power of the rosin was high, thus sufficiently reducing the surface of the CuNi alloy powder sufficiently with the rosin.

It is to be noted that the increased acid number of the rosin is equivalent to the increased amount of a resin acid. The carboxyl group of the resin acid and an oxide film at the surface of the second metal powder react during heating, thereby removing the oxide film. Therefore, the rosin with a larger acid number has a greater effect of reducing an oxide film at the metal powder surface.

Therefore, the TLP reaction proceeds through a heat treatment at a relatively low temperature in the respective samples 9 to 12. As a result, the respective samples 9 to 12 serve as highly heat-resistant materials.

### Other Embodiments

It is to be noted that the material for the first metal powder 106 is the single element Sn in the present embodiment, but not to be considered limited thereto. In practice, the material for the first metal powder 106 may be an alloy containing Sn (specifically, an alloy containing Sn and at least one selected from the group consisting of Cu, Ni, Ag, Au, Sb, Zn, Bi, In, Ge, Al, Co, Mn, Fe, Cr, Mg, Mn, Pd, Si, Sr, Te, and P).

In addition, the material for the second metal powder 107 is the CuNi alloy in the present embodiment, but not to be considered limited thereto. In practice, the material for the second metal powder 107 may be, for example, one or more types of powders selected from the group consisting of CuNi alloys, CuMn alloys, CuAI alloys, CuCr alloys, AgPd alloys, and the like.

In this regard, in the case of utilizing the liquid-phase diffusion (TLP) reaction, heat treatment conditions (temperature and time) which are appropriate for the materials may be set.

In addition, in the heating step according to the embodiment described above, far-infrared heating or high-frequency induction heating may be carried out, besides the hot-air heating.

Finally, the descriptions of the embodiments should be considered by way of example in all respects, but non-limiting. The scope of the present invention is not defined by the embodiments described above, but by the claims. Furthermore, the scope of the present invention is intended to encompass all modifications within the spirit and scope equivalent to the claims.

### DESCRIPTION OF REFERENCE SYMBOLS

20: ceramic laminated body
21: land
22: printed wiring board
23: external electrode
24: electronic component
25: metal paste
30: intermetallic compound member
31: metal putty
32: metal member
50: bolt
60: nut
100: bonded structure
101: first object to be bonded
102: second object to be bonded
104: bonding material
105: metal composition
106: first metal powder
107: second metal powder
108: flux
109: intermetallic compound phase
110: metal component
300: rolled body
303: repairing sheet
310: pipe
DP: damaged part

1. A metal composition comprising:
a metal component comprising a first metal powder and a second metal powder that has a higher melting point than the first metal powder; and
a flux component,
wherein an amount to be reduced by hydrogen reduction of the second metal powder is 0.75 wt % or less.

2. The metal composition according to claim 1, wherein the first metal powder is one of a Sn powder and an alloy powder comprising Sn, and the second metal powder is a Cu-based alloy powder.

3. The metal composition according to claim 2, wherein the Cu-based alloy powder is a CuNi alloy powder.

4. The metal composition according to claim 1, wherein a specific surface area of the second metal powder is 0.61 m²/g or larger.

5. The metal composition according to claim 4, wherein the specific surface area of the second metal powder is 0.61 m²/g to less than 1.15 m²/g.

6. The metal composition according to claim 4, wherein the flux comprises a rosin and an activator, and a ratio of a weight of the activator to a weight of rosin is 1.0 or more.

7. The metal composition according to claim 6, wherein the ratio of the weight of the activator to the weight of rosin is 1.0 to 2.0.

8. The metal composition according to claim 6, wherein the rosin has an acid number of 130 or more.

9. The metal composition according to claim 6, wherein the rosin includes at least one of a rosin-based resin and a synthetic resin.

10. The metal composition according to claim 6, wherein the activator comprises a carboxyl group.

11. The metal composition according to claim 10, wherein the activator is selected from the group consisting of a hydrohalogenic acid salt of an amine, an organic halogen compound, an organic acid, an organic amine, and a polyalcohol.

12. The metal composition according to claim 1, wherein the second metal powder has a specific surface area of 0.61 m²/g or less.

13. The metal composition according to claim 12, wherein the flux component comprises a rosin and an activator, and the rosin has an acid number of 130 or more.

14. The metal composition according to claim 13, wherein the first metal powder is one of a Sn powder and an alloy powder comprising Sn, and the second metal powder is a Cu-based alloy powder.

15. The metal composition according to claim 14, wherein the Cu-based alloy powder is a CuNi alloy powder.

16. The metal composition according to claim 13, wherein a ratio of the weight of the activator to the weight of rosin is 1.0 to 2.0.

17. The metal composition according to claim 13, wherein the rosin includes at least one of a rosin-based resin and a synthetic resin.

18. The metal composition according to claim 13, wherein the activator comprises a carboxyl group.

19. The metal composition according to claim 18, wherein the activator is selected from the group consisting of a hydrohalogenic acid salt of an amine, an organic halogen compound, an organic acid, an organic amine, and a polyalcohol.

20. A bonding material comprising the metal composition according to claim 1.
